(19) United States
(12) Patent Application Publication
(10) Pub. No.: US 2009/0223395 A1
(43) Pub. Date: Sep. 10, 2009

(54) INK FOUNTAIN LINER

(76) Inventor: Lars Jepsen, Nyborg (DK)

Correspondence Address: AKC PATENTS, 215 GROVE ST., NEWTON, MA, 02466, US

(21) Appl. No.: 11/720,885

(22) PCT Filed: Dec. 10, 2004
(86) PCT No.: PCT/DK04/00872

§ 371 Date: Jun. 27, 2007

(51) Int. Cl. B41F 31/02; B32B 37/02

(52) U.S. Cl. 101/364; 156/256

(57) ABSTRACT

Liner for a radial-type ink fountain in a printing machine; ie. the sloping ink fountain bottom's lower edge is, via a nip with gap-adjustment by edge-positioning for controlled metering of ink, opposed an ink roller dragging down ink adhering to the ink roller surface during downward rotational movement. The liner (19) has panel(s) to cover else ink-wetted areas in the ink fountain reservoir, thus having a bottom panel (20) with a longitudinal edge (24) extending along the ink fountain bottom's edge adjacent the nip, when installed. Ink penetration between the liner underside and the ink fountain bottom surface from the nip-area is inventively avoided by primary adhesive means (25) striplike continuously extending along bottom panel's edge (24) nearest the nip to sealingly joining the bottom panel edge-area to the ink fountain bottom without bottom panel edge protruding freely towards the ink roller. Manufacturing methods are also claimed.

### FIELD OF APPLICATION

This invention concerns an ink fountain liner for at least covering substantially the printing-ink-wetted bottom surface and side structures of an ink fountain of radial type in a printing machine, and moreover being as specified in the preamble of claim 1. The invention also concerns methods of manufacturing such liner.

### BACKGROUND, DEFINITIONS

An ink fountain is used in a printing machine to deliver the highly viscous, pasty, slow-flowing printing ink to the machine's printing process. The printing machine and the printing process performed therein can be of any suited known type and can eg. make use of screens, cylinders and/or plates etc. to perform the print of a pattern of any kind on any suitable material as eg. paper, polymer film, carton, which can be present as (a part of) a sheet or as a web of material from a supply roll. The printing ink in one fountain normally represents one nuance of colour for the printed output. Does the printed output require more than one nuance, printing with supplementary nuance(s) can eg. be performed as a new run on the same machine, now having the ink in the fountain being replaced with ink of the next desired nuance; or a machine can contain more stations in a series, each station being able to deliver and print one nuance, the material for printing then being sequentially passed from one station to the next for printing (often four basic nuances are selectively combined as “invisible” small points to yield any desired nuance in the visible scale).

No more details related to printing machines and processes as such will be given here, as they have minor relevance to the invention and are expected to be sufficiently understood by a reader with knowledge to the art.

Though, to fully understand is, that the ink fountain functions as a reservoir for the ink and basically consists of an upfacing bottom surface, whereon the pasty, slowflowing printing ink is “lying”. The bottom surface is sloping downwards towards the circular cylinder face of a substantially horizontal rotatable ink roller, which is defining the opposed sidewall of the reservoir. To keep the ink inside the reservoir at it's ends, the fountain has upstanding end-structures sealingly connected to the bottom surface structure. These end-structures are also sealingly addressing the ink roller eg. by sliding against the roller's end faces. During use, the ink mass also is in contact with the ink roller, which by it's downward rotating movement is “dragging” down ink through a narrow nip, which is defined to extend between the side structures and reach from the fountain bottom surface to the nearest part of the ink roller's cylinder face.

From the ink roller the ink is transferred further for the printing process by another roller rolling on the ink roller according to a controlled pattern of movement. Basically, from one point on the fountain bottom surface at the nip, a narrow stripe of ink will be dragged through the nip by the ink roller, which will accumulate the ink as a narrow circular circumferential ring. The ink from such ringshaped area is partly being collected by the another roller. Ink from this point/ring will basically end up in a stripe on the surface of the printed output, meaning that—according to the graphics to print—the demand for ink of the actual nuance might vary in the direction square to the stripe mentioned, ie. along the extension of the nip adjacent the ink fountain bottom surface.

Therefore the gap of the nip is adjustable to control an ink delivery reflecting the demand from the printed output.

Two types of adjustment principles are known, of which the one here called “the radial type” is relevant for the invention (the other type is here referred to as the “tangential type”).

In the ink fountain of the relevant “radial” type the gap of the nip is defined between the adjacent edge of the fountain bottom surface and the nearest “line” on the opposed circular cylindrical surface of the ink roller, meaning the bottom surface of the fountain roughly is following a radial plane from the ink roller axis. Said edge of the fountain bottom surface is divided into a number of sections each eg. being the edge of a respective segment, that in a roughly radial direction (up to +/−75° hereto) is movable towards or away from the opposed surface of the ink roller, thus defining the gap in this section of the nip's extension along the ink roller. The segments are precision parts being positioned close to each other along the nip, thus preventing the ink from escape between adjacent segments. Some means are installed to perform the adjustment movement and the fixing of the segments; these means being operable manually or by a more or less automated controlling system. These means are normally shielded from the reservoir, which presents itself with relatively smooth surfaces to be wetted by the ink.

When shifting to ink of another nuance in a printing machine, it is necessary to clean the ink fountain: the major part of the remaining ink used hitherto must be removed—a job that is often performed by use of a spatula to “dig off” residual ink; minor residues are wiped off with rags soaked with solvent. Even in a machine/station running without shift of ink type/nuance it is with a certain periodicity necessary to empty and clean the ink fountain to avoid deposits of hardened/dried ink and eventual local clogging of the nip.

The cleaning job, which is very intensive in manual labour, is time-consuming and therefore very costly, both in labour costs and in costs due to loss of productivity of the printing machine, which is heavy investment equipment, as the printing machine must be out of production during the cleaning period.

Therefore liners for ink fountains have been invented.

### Prior Art and the Problem:

A fountain liner is meant to cover the else ink-wetted surfaces of the ink fountain by being positioned in a clean(ed) ink fountain before the ink is introduced, thus shielding parts of the surfaces in the fountain from being wetted from the ink. Being normally configured as a disposable article, a lot of costly cleaning time (and machine down time) can be saved, as the “old” ink in a desired quantity simply is removed from the surface(s) of the liner defining the reservoir, before the complete liner with the residual adhering ink is removed from the ink fountain and is disposed of, thus to leave the hitherto shielded areas of the ink fountain surfaces in principle unaffected from ink, thereby reducing the need for cleaning.

A known liner for an ink fountain of radial type for at least covering substantially the fountain's else ink-wetted bottom surface and side structures is made of suitable sheet material (eg. polymer/metal/laminated cardboard etc.) of suitable thickness (to resist eg. attacks from a spatula); the liner comprises at least a bottom panel (for at least substantially to cover an ink fountain bottom else wetted by ink) and possible opposed suitably contoured side panels, which via bending lines/areas must be integral with the bottom panel, (for substantially to cover the else ink-wetted possible side structures of same ink fountain); when installed in an actual fountain—to the size of which the liner must be suitably adapted—the bottom panel's longitudinal edge nearest the nip has no positive protrusion towards the ink roller, over the fountain bottom's edge adjacent the nip, as this would interfere with the adjustment of the gap of the nip (to the contrary: the non-relevant “tangential type” fountain has its bottom surface extending substantially tangentially to the ink roller, often reaching past the nearest “line” on the ink roller's cylindrical surface at the nip; gap adjustment can then be performed by swinging faces of segments at the nip towards or away from the ink roller; due to the relatively smooth surface extension of the fountain bottom/segments facing the ink roller at the nip, it is known to pass a liner through the nip in such non-relevant tangential type fountain). The liner possibly comprises supplementary gripping tabs for easy lifting off/handling of the used liner without the operator's hands being dirtied from ink, and the liner possibly comprises added secondary adhesive fastening means in the form of spotwise applicated adhesive material especially at the side panels facing the upstanding side-structures to reduce openings for ink entrances in this area. The liner can also be prepared for other fastening than with adhesive means, eg. by magnetic or vacuum means, to help to keep the liner seated in the ink fountain during use.

A known liner for a radial-type ink fountain, of substantially above type, which is recognized as the most relevant prior art, is represented by the liner described in DE-U-8813883.

A severe problem arising from prior art liners is due to the fact, that an edge of the liner inherently is extending along the nip, thus leaving possibility for the ink here to enter in between the underside of the liner and the bottom surface of the fountain. Prior art liners has not proven themselves able to establish a satisfying barrier against such ink entrance, even if they are held in position by means of a costly vacuum system and/or magnetic system acting on the liner's bottom panel over most of the panel area.

### Object of the Invention and its Fulfilment:

The primary object of the present invention is to remedy the abovementioned problem with ink entering in at the liner's edge adjacent the nip, by providing an improved liner. Another object is to provide methods for producing a liner according to the present invention.

Other objects will be clear from the description to follow and from the claims.

Investigations have revealed, that even a small imperfection in the placement of the liner's edge adjacent the nip can lead to ink intrusion between the liner and the fountain bottom, which is aimed shielded, such imperfection eg. being related to even small fins from the contouring of the liner's edge, residues from inadvertent bending during installation etc. Also an uneven fountain bottom surface might be the source of such imperfect placement of the liner's edge adjacent the nip.

Moreover, analysis has shown, that the tendency for the ink to enter this region—besides this area always during use being wetted by the ink—is accentuated by the pattern of movement of the ink roller relative to the edge of the fountain bottom at the opposed side of the gap: pronounced shear forces are created in the highly viscous, paste-like ink, as part of it is drawn down through the nip by adherence to the ink roller; these shear forces create a rotating vortex in the remaining ink in the fountain, so this ink might be observed as a massy structure slowly rolling contacting the ink roller, but still in pronounced contact with fountain bottom/liner bottom panel. The pumping effect from this vortex, that is most pronounced at the fountain bottom/liner bottom panel edge just beside the nip, tends to lift the liner's edge and/or to force ink into even the smallest opening between the liner base panel and the fountain bottom, and once having created/“found” an opening, the vortex' shear forces tend to continuously pump in more and more ink; a large area of the fountain bottom under the liner can be covered and thus dirtied. The ink so distributed under the liner bottom panel also shows tendency to additionally lift the liner making the edge near the nip even more vulnerable to ink intrusion and possibly makes the liner “floating”; ink might be sucked into a vacuum system, and a floating liner caught by the ink roller and possibly drawn through the nip can lead to various more or less “unpredictable results”—the effects in all cases being costly to remedy.

Thus, the primary object of the present invention is fulfilled by means of a liner of the type according to the preamble of claim 1, such liner according to the present invention further being characterized in—when installed in the actual fountain—that the liner bottom panel comprises primary adhesive means extending continuously along the bottom panel's longitudinal edge positioned adjacent the nip, and in that these primary adhesive means exhibits at least no negative protrusion towards the nip/ink roller from the bottom panel's edge positioned adjacent the nip, and further in, that the primary adhesive means is sealingly joining the bottom panel's edge adjacent the nip to the fountain bottom.

### The Effect of the Characterizing Means:

The beneficial effects resulting from the characterizing means are multiple: The primary adhesive means' extension continuously all along the liner's edge adjacent the nip, secures the possibility all along the edge to fasten and seal the liner against the fountain bottom.

The avoidance of negative protrusion of the primary adhesive means in the installed situation secures the liner bottom panel sheet material from protruding towards the nip/ink roller; thus the risk of lifting forces on the bottom panel, resulting from trapped ink pumped on by the vortex, is eliminated.
And, as the primary adhering means is sealingly joining the edge of the base panel adjacent the nip to the fountain bottom, no openings are left for abovementioned intrusion of ink under the liner, even if small imperfections should exist at the linier's edge and/or in the underlying fountain bottom surface.
The combined result of the characterizing means is therefore, that a liner according to the present invention, when installed, can be securely seated and fixed in an ink fountain, sealing all possible openings at the liner's edge near the nip and eliminating trapping of pressurized ink to lift the liner—all the time during a planned production run and until the liner by will is removed.

Preferably the invention's liner also comprises the primary adhesive means before the liner is installed in an actual fountain. This means that the primary adhesive means in advance can be applicated to the liner, eg. in a factory during other production steps for the liner, thus permanently securing the accuracy and quality of application of the primary adhesive; also meaning less time necessary for the installation of the liner in the ink fountain, ie. machine down time is further reduced.

The invention's liner might also beneficially have the primary adhesive means installed to the bottom panel's surface facing the ink fountain bottom. As the primary adhesive means in this embodiment does not have to overlap the edge of the liner, it is possible to cover a larger area of the ink fountain bottom near the nip with liner bottom panel. Also, normally, different sides of the primary adhesive means then will contact the liner's underside and the ink fountain bottom respectively, making it easier to select the appropriate types of adhesive material dedicated for the liner material and the ink fountain bottom material respectively. A highly demanded property of the primary adhesive materials is, that no residues are left on the ink fountain bottom material after removal of the liner. Another desired property of these adhesives being, that repositioning of the liner during installation in a clean(ed) ink fountain bottom is possible after the first stick of the adhesives, without affecting their function during the subsequent production run.

As the primary adhesive means normally are in the form of adhesive tape carrying adhesive on one or both of it's sides according to the actual embodiment, the primary adhesive means in its longitudinal direction preferably is extended also to partly cover the side panels, when applicated to the intended underside of the liner. So, the continuous strip for primary adhesive means can also function to join the side panels to the upstanding side structures of the ink fountain, thus reducing the risk of entrance of ink between the side panels and the end structures.

Another beneficial means hereto is to additionally or alternatively exploit the elastic bending forces at the bending lines/areas to give a contribution to the tight placement of the end panels in covering the ink fountain's end-structures. Stiffer/better elastic behaviour is often achieved by means of a method of manufacturing, wherein the invention's liner's sheet material is so taken from a roll of sheet material, that the edge of the liner's bottom panel to be positioned adjacent a nip, substantially is extending in the longitudinal/roll-off direction of the material web from the roll, as web material often is stiffer in this direction due to production methods.

Such liner production method also facilitates the application of continuous strip primary adhesive means, as this can be “rolled to” the web before or after the shaping of the bottom panel's edge to be adjacent the a nip. Of course also the adhesive strip itself can be contoured according to specific needs.

Another beneficial production method for the invention's liner comprises using primary adhesive means, which is covered with a protective strip to be peeled off at installation time: this will protect the adhesive during further production steps and storing; also at installation time a possibility to slide the liner into its correct position before activating the adhesive is a highly esteemed feature; after final correct positioning of the liner, the protective strip is peeled away permitting the fixing and the sealing of the edge near the nip by means of the adhesive material(s).

To facilitate a better and more profound understanding of the present invention a description of preferred embodiments of the invention's liner will now be given as non-limiting examples, as the full scope of the invention is defined by the appended claims.

### FIGURES

Reference will be made to the drawing, wherefrom:

FIG. 1 shows—very schematically—a section in the production direction of a part of a printing machine/station comprising an ink fountain and an ink roller;

FIG. 2 schematically shows a vertically sectioned ink fountain, ink roller and related parts;

FIG. 3 shows a pespective of an embodiment of an ink fountain liner according to the present invention, folded as installed in an ink fountain like one in FIG. 2;

FIG. 4 schematically shows—from an embodiment of an ink fountain liner according to the present invention; eg. one as in FIG. 3—partly the liner bottom panel with it's edge before installation adjacent a nip; the primary adhesive means; and partly the fountian bottom, all sectioned square to the panel's edge;

FIG. 5 schematically shows the three parts like those in FIG. 4 after installation adjacent a nip;

FIG. 6 schematically shows an alternative installation of a liner according to the present invention;

FIG. 7 schematically shows another alternative installation of a liner according to the present invention;

FIG. 8 illustrates schematically methods according to the present invention to produce liner(s) according to the present invention; and

FIG. 9 illustrates schematically other methods according to the present invention to produce liner(s) according to the present invention.

### DESCRIPTION OF EMBODIMENTS

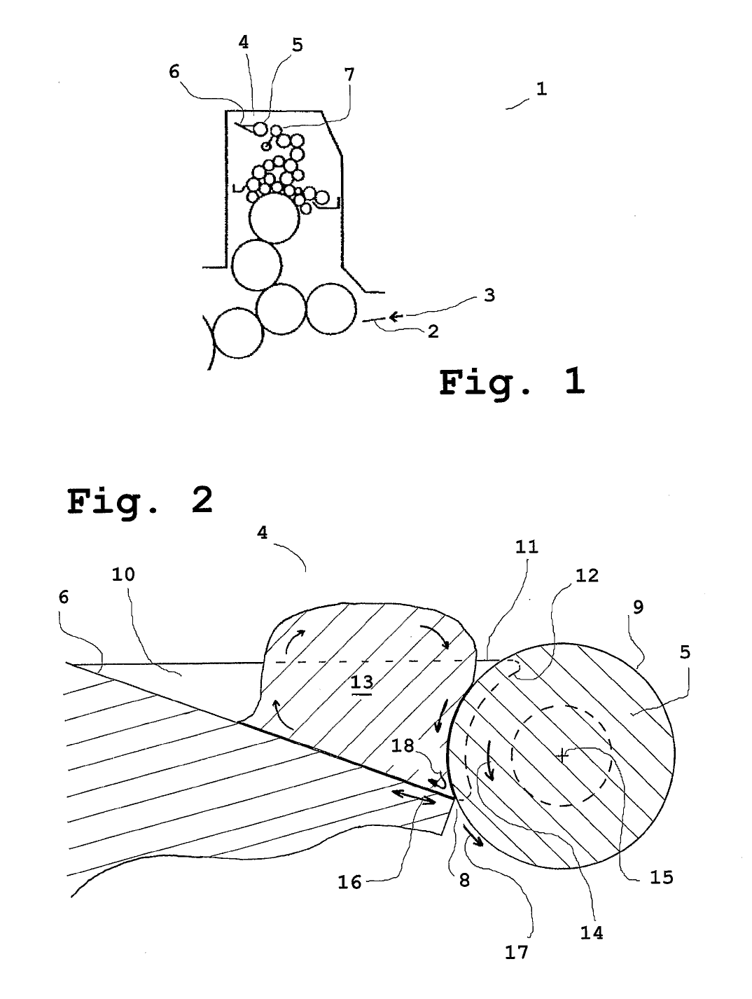

FIG. 1 shows—roughly and very schematically—a part of a sectioned printing machine/station 1. The sheet or the material web to be printed 2 is entering in the direction of the arrow 3 and might be delivered form a stack of sheets or from a roll possibly already printed with one or more nuances in (not shown) station(s) upstream. In the station 1 the material 2, which can be of any suited type, is printed with ink from an ink fountain 4 by means of any known suited proces, which here is symbolized as the big circles low in the figure. The material leaves the machine/station preferably to the left for possible subsequent printing in an adjacent station or other handling—as well known in the art. An ink roller 5 is on its circular surface accumulating ink from a reservoir formed between the ink roller 5 and the ink fountain's bottom's downsloping surface 6, by rotating downwards passing a nip established between the edge of the ink fountain bottom and the ink roller.

From the ink roller 5 the ink is transported further for the printing process by another roller 7 rolling on the ink roller according to a controlled pattern of movement.

FIG. 2 illustrates the patterns of movement of the essential parts at an ink fountain 4, which is schematically shown sectioned normal to the ink roller's 5 axis 15. The nip 8 is the narrowest opening extending along the ink roller and reaching between the fountain bottom 6 and the ink roller 5. The fountain bottom surface 6 is sloping downwards towards the ink roller 5, the bottom's 6 limiting edge adjacent the nip 8 being positioned in a controlled distance, ie. “the gap” of the nip, from the ink roller's circular cylindrical surface 9. The reservoir 10, to the sides limited by the fountain bottom 6 and the cylinder 9, is at it's ends limited by upstanding end-structures 11 sealingly connected to the bottom surface 6 structure. These end-structures 11 are also sealingly addressing the ink roller 5, eg. by sliding against the roller's end faces as shown with the broken line at 12 outside the roller's shaft with smaller circumference—indicated by a broken circle. Besides being in contact with the fountain bottom 6 and possibly the end-structures 11, the massy ink 13 during operation also is in contact with the ink roller, which by it's downward rotating movement—arrow 14—about it's axis 15 is “dragging” down ink through the nip 8.

In principle from one point on the fountain bottom surface at the nip, a narrow stripe of ink 13 will be dragged through the nip 8 by the ink roller 5, which will accumulate the ink as a narrow circular circumferential ring-segment before further transfer. As the demand for ink of the actual nuance can vary in the direction along the nip's extension parallel to the axis 15, the gap of the nip is adjustable along the cylinder 9 to control an ink delivery reflecting the demand from the printed output.

In an ink fountain of the relevant “radial” type, the gap of the nip 8 is defined between the adjacent edge of the fountain bottom surface and the nearest “line” on the opposed circular cylindrical surface 9, meaning, that the bottom surface 6 of the fountain roughly (up to aprox. +/−75°) is following a radial plane from the ink rollers' axis 15. This edge of the ink fountain bottom surface is divided into a number of sections each eg. being the edge of a respective segment (not shown in detail), which in a roughly radial direction—double-arrow 16—is movable towards/away from the opposed surface of the ink roller 5, thus defining the gap in this section of the nip's 8 extension along the ink roller. The segments are precision parts being positioned close to each other along the nip, thus preventing the ink 13 from escape between adjacent segments.

The problem, that initiated the inventive efforts, showed to mainly rely on the pattern of movement of the ink roller 5 relative to the edge of the ink fountain bottom 6 in combination with the highly viscous printing ink 13 normally used in relevant printing processes: pronounced shear forces are created in the paste-like ink, as part of it is drawn down through the nip by adherence to the ink roller—arrow 17; these shear forces create a rotating vortex in the remaining ink 13 in the fountain; this ink 13 might therefore be observed as a massy structure slowly rolling contacting the ink roller, but still in pronounced contact with ink fountain bottom and/or liner bottom panel (if installed, covering the ink fountain bottom), as indicated with the small arrows inside the ink 13 section. The pumping effect from this vortex, that is most pronounced at the ink fountain bottom/installed liner bottom panel edge just beside the nip—at angled arrow 18—tends to lift an installed liner's edge and/or to force ink into even the smallest opening between such liner bottom panel and the ink fountain bottom.

Left still for a period of time, the ink 13 tends to level out filling the reservoir 10 below a substantially horisontal ink top face. As the volume of the reservoir is limited by the lowest of: ink fountain bottom 6 upper edge; ink roller cylinder 9 top-point-line; and end-structures' 11 top faces, this must be taken into account, eg. when topping up ink during production.

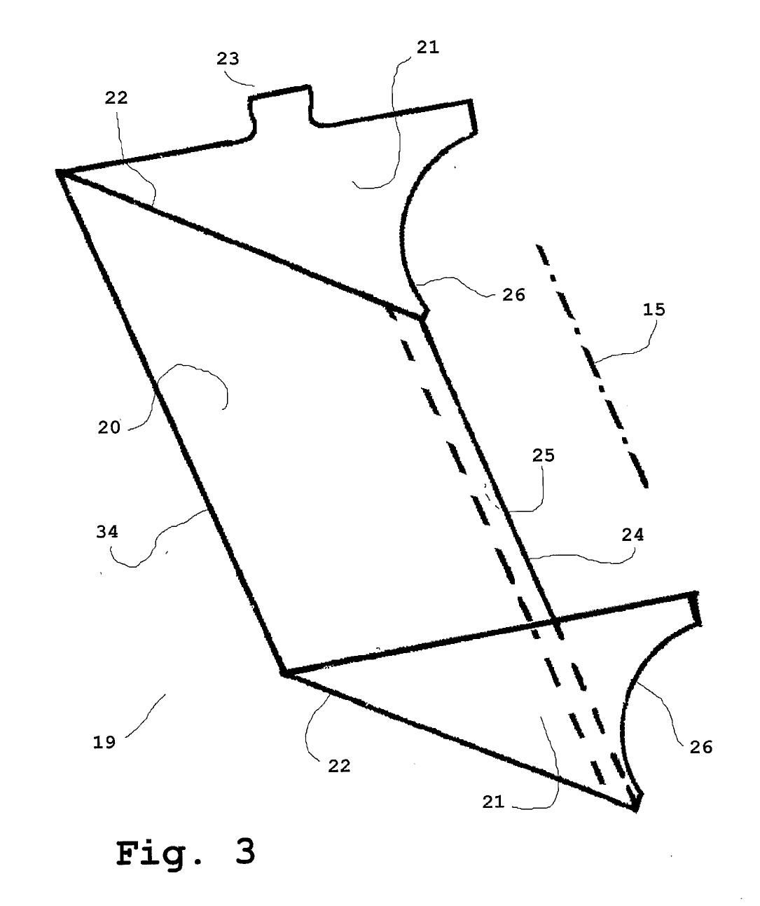

FIG. 3 shows an ink fountain liner 19 according to the present invention, bent/folded as installed in an ink fountain of radial type like the one in FIG. 2. The liner is made of suited sheet material, eg. polyester foil of approx. 0.2 mm thickness, as this will adequately resist scratching from a spatula during handling of the ink and also is compatible with the physical and chemical environment of the ink/printing machine, besides it being environmentally non-problematic to dispose of; also other sheet materials as other polymers, metal foil or layered structures are comprehensible as liner material. In FIG. 3 the liner's up-facing side of the bottom panel 20 is easily identified as well as the end panels 21, which via the bending lines 22 are integral with the bottom panel 20. The bottom panel 20 is intended to cover at least the substantial part of an ink fountain's bottom surface else wetted by ink (see 6 & 13, FIG. 2) and is sized accordingly; the bottom panel's 20 edge 24 is to be positioned adjacent the nip (see 8, FIG. 2). The liner's 19 primary adhesive means 25 is in the embodiment shown applicated to the side of the bottom panel 20 to face the ink fountain bottom and has the form of a continuous strip of adhesive tape covered with a downfacing protective layer to be stripped off at installation time.

The end panels 21 are contoured to match and cover substantially at least the else ink wetted areas of the end-structures (11, FIG. 2) and comprise adapted contouring 26 at the edges towards the ink roller (5, 9; FIG. 2) to avoid ink penetration behind an end panel 21 from a possible ink level at the contour's edge 26. Possible gripping tabs might be fitted or contoured at eg. end panels outside ink-wetted areas (eg. as shown at 23) for allowing an operator to remove the used liner soiled with ink residues, without self being soiled by ink.

The overall installation of a liner according to the invention in an ink fountain of radial type is now comprehensible by referring to FIGS. 2 and 3.

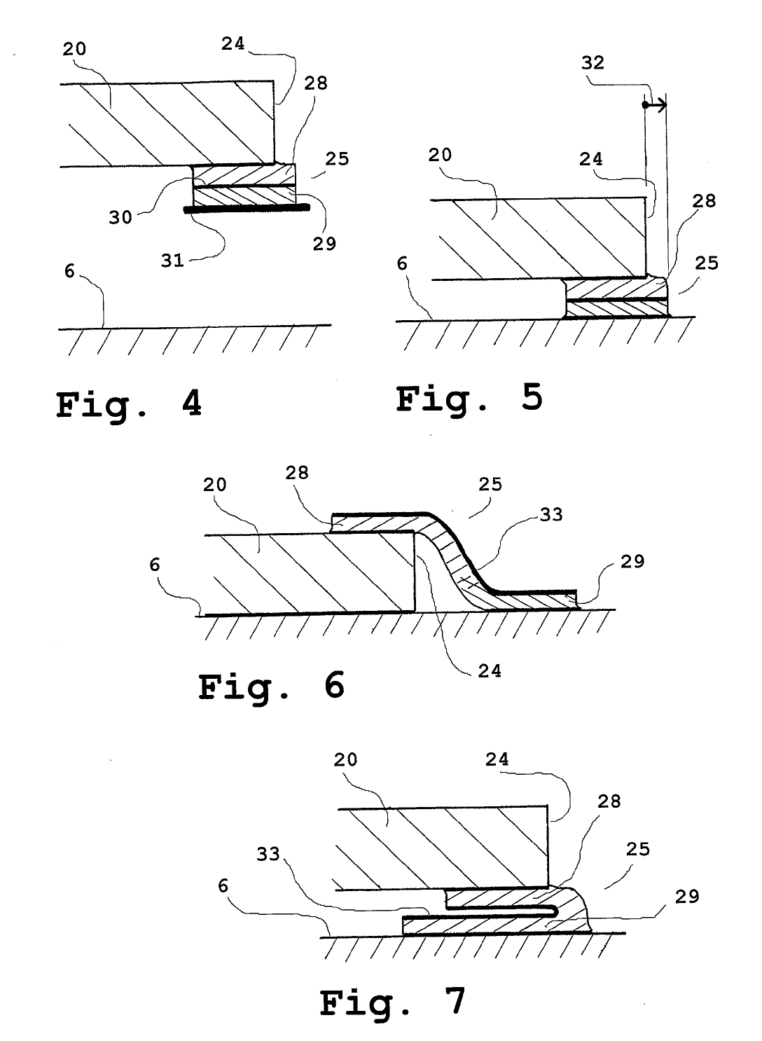

Installation details of the liner and primary adhesive means to the fountain bottom adjacent the nip will now be explained with reference to FIG. 4-7. These figures are diagrammatically and out of scale—even relatively—for reasons of clearity. Shown are sections square to the ink roller axis (15; FIGS. 2 & 3) of a cut-off of: an ink fountain bottom 6; a liner bottom panel's 20 edge 24 (to be) adjacent the nip; and the primary adhesive means 25, to illustrate different forms of application of the primary adhesive means and installation of the liner according to the invention. The reference numbers for like or similar items are reused/repeated.

FIG. 4 shows a highly preferred embodiment of the invention's liner 20, positioned above an ink fountain bottom 6, but not yet laid down thereon. The primary adhesive means 25 has in the form of a strip in advance been applicated along the liner's edge 24 to sit adjacent the nip on the side facing the ink fountain bottom 6. Due to possible difference in liner and bottom materials and expectancy for proper functioning during production time and easy and full removal of the liner including all primary adhesive means at disposal time, it is often beneficial, that the primary adhesive means 25 comprises a layered structure with liner adhesive 28 contacting the liner material 20, and bottom adhesive 29 to contact the fountain bottom material 6, respectively selected and dedicated to the actual local and general requirements. The liner/bottom adhesives 28/29 are mutually sealingly connected eg. by means of a suited between-layer (structure). The face of the still uninstalled bottom adhesive means 30, is covered by a protective strip 31 to be removed at installation time.

The embodiment can be manufactured in advance to quality standards, can be stocked ready for use in the printing room near the actual place of use, and is very easy and speedy to install. Especially when eg. the liner bottom panel's top edge (34; FIG. 3) can be slid against suitable fix stops opposed the fountain bottom's edge adjacent the nip, positioning is very speedy (the positioning square hereto being guided by the end-structures). When in correct position, the operator immobilizes the liner by pressing on the bottom panel 20 with one hand, while with the other hand the protective strip 31 is removed from between the ink fountain bottom 6 and the counterlying bottom adhesive 30 for an immediate mutual bond. A force applied through the liner material 20 against the fountain bottom 6 all along the edge 24, eg. by means of a sliding finger or a simple suited tool (ball pen, spatula, etc) is thereafter enough to properly terminate the liner installation; during this last step it is secured, that the primary adhesive means 25 also fulfills it's function as a sealing means by filling/adapting to all imperfections at the relevant edges/faces.

The liner from FIG. 4 is shown installed in FIG. 5. Here note, that the primary adhesive means has a positive (at least: “not negative”) protrusion 32 compared to the liner's edge 24, thereby protecting the edge 24 from being lifted by trapped ink pumped from the vortex of ink (13, 18; FIG. 2). Of course FIG. 5 can also be perceived as the result of another installation sequence: the primary adhesive means first being applied to the ink fountain bottom, the liner then being positioned on the fountain bottom, and the contact between liner and liner adhesive 28 finally being established. Such method is less recommendable, as it is much more tricky, involving many parts to be positioned/handled/removed with high accuracy almost simultaneously, also costing extra due to prolonged downtime and probability for the liner/adhesive complex to malfunction during production due to incorrect mounting in a severe hurry.

When the spectrum of requirements to the primary adhesive means 25 in an actual situation can be fulfilled by a single adhesive material, only one layer hereof, thus being the primary adhesive means, is necessary between the liner and ink fountain bottom materials and can be applicated as a strip, eg. carried on a removable protective layer; then a layer thickness of approx. 35 micrometers normally will prove satisfying. Are dedicated adhesive-types necessary as liner adhesive 28 and bottom adhesive 29 respectively, also approx. 40 micrometers of totaled adhesive thickness is normally required. In such case, the total thickness of the primary adhesive means often must be augmented with the thickness of an intermediate joining layer of approx. 20 micrometers, often and preferably in the form of a strip of polyester film. A strip width of approx. 20 mm has proven succesfull.

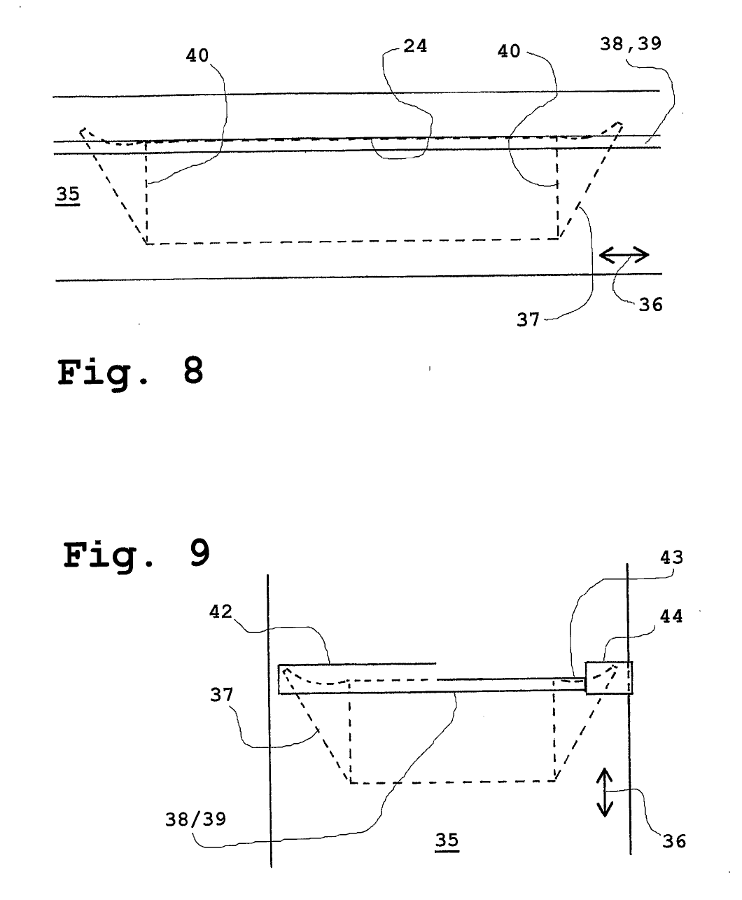

In FIGS. 6 and 7 other of the possible installation patterns of the liner with the primary adhesive means are shown. The basics are as described above, and also here various mounting sequences are perceiveable; eg. from FIG. 6: means 25 first to liner 20, then liner plus means to bottom 6; liner first to bottom, then means 25 simultaneously to both; etc. The embodiment in FIG. 6 often requires different adhesives 28/29 extending adjacently on the same side of an inevitable backing strip 33—a costly construction. As the positioning of the liner also is less accurate and has a small play to and fro the nip, an embodiment according to FIG. 4/5 is often a better choise. The FIG. 7 embodiment also has the adhesive(s) applicated to one side of a backing strip and can also be installed in different, easily conceivable sequences. Here, more adhesive is exposed to the ink, but the possibility for adjustment by slide-rolling the primary adhesive means 25—especially with more or less contact-width to the ink fountain bottom 6—can make this embodiment the preferred one, if the liner according to the invention must adapt to afterwards being clamped or held by other fastening (vacuum and/or mechanical) means, eg. at restart of the machinery.

Production methods for the liner according to the invention will now be discussed.

FIG. 8 illustrates schematically some production methods, in common featuring, that the liner panels are located in the sheet material (web) 35 with the edge 24 of the liner's bottom panel to be positioned nearest a nip, substantially extending in the longitudinal/roll-off direction (arrow 36) of the sheet material (web from a possible roll). An exemplifying contour 37 of a liner is shown in broken lines, to be perceived to be lying below a stripe 38 of primary adhesive, preferably covered by an upfacing protective strip 39 for above discussed reasons. The stripe 38/39 is extending in the production direction 36 and can eg. be rolled to the sheet 35 for tight adherence, as a continuous length or as metered lengthes to just cover the necessary extension of a respective (future) liner 37 below. After application of the adhesive strip the liner contour 37 including the strip 38/39 can be more or less freed from the remaining sheet material 35 by a cutting or stamping operation, the latter also possibly being performed as a “rolling” operation, thus inducing to such production method a high degree of continuity and smooth movements, allowing for high production rates. During severing of the sheet material 35 at the liner's edge 24 to be positioned adjacent a nip, an offset of the strip can possibly be included for securing a controlled “not-negative” protrusion of the adhesive means from the liner's edge, if such protrusion is not controlled by exact lateral positioning of the strip on the web 35 compared to the future severing line; then only severing of the sheet material layer is necessary along the liner's edge. Eg. simultaneously with the cutting/stamping also possible bending lines 40 can be defined in the sheet material 35. Among the advantages of the just described methods are, that a liner with a long edge (eg. of approx. 1 m to fit widespread relevant printing machines of “40-inch”-size) can be produced utilizing a relatively narrow web on “narrow” equipment; and often web material is somewhat or deliberately stretched in it's own production direction, also 36, yielding more stiffness in this direction to be additionally exploited as stronger springy forces at the bending lines/areas to better maintain the end-panels' seating against an ink fountain's end-structures. As to be seen from FIG. 8, adhesive strip extending on the side panels of course also can contribute to their immobilization to the end-structures, when installed in a fountain.

In FIG. 9 the liner is (to be) located with it's “nip-edge” square to the production direction 36 of the sheet material 35; also, the adhesive strip 38/39 is preferably applied in the same square direction. To the left in FIG. 9 is shown a possibility to cover all part of a sidepanel's contour (26; FIG. 3) to be adjacent an ink roller by means of a relatively wide strip 42 of adhesive, if this is functionally demanded and is required from the actual liner dimensions 37. By use of less area of adhesive material the same effect can be obtained as shown to the right in FIG. 9, where successive adhesive strips 43, 44 of dedicated width are also covering all part of a sidepanel's contour to be adjacent an ink roller. Many types of adhesives for the primary adhesive means, especially if constructed as shown in FIG. 4, can compensate for an overlap of two consecutive stripes of primary adhesive means, allowing for a sufficiently “safe” tolerance in the placement of eg. the wider strip/pad 44 after the application of the narrower strip 43 to the liner material 35. The FIG.-9-methods might be best suited for liners for relatively “narrow” relevant printing machines (10-, 15-inch types) and allow for a tight “packing” of liners in a web's direction 36. Relatively smaller liners might also most econimically be stamped more or less free of the sheet/web material with a planer tool, but still according to aboventioned “protrusion-principles” for the primary adhesive means.

Of course the liner material alternatively can be more or less finally contoured before application of the primary adhesive, the contour not being restricted in angular positioning to a principal direction, eg. 36, of the sheet material (a sheet might be partly exploited by diagonal placement of a liner with longest dimension exceeding available sheet length).

In the figures the liner is shown to comprise planar panels with rectilinear free edges only, but of course liners with 3-Dimensionally contoured panel(s) and/or curved edge(s) for better fit and guidance in an actual ink fountain, are also scoped by the appended claims. Such 3-D contouring might be made by eg. pressing, stamping or thermoforming during a suitable step in the liner production process. The shape of ink fountains demanding such 3-D-contoured liners according to the invention, might render specific side panels superfluous, as the function thereof might be more or less distinctly integrated in the liner's bottom panel.

Moreover, many other embodiments of the invention's liner and methods of production thereof are conceivable to be performed by a person skilled in the art by using/combining any of the constructive and/or methodic details/principles mentioned herein, without such embodiments are leaving the claimed scope of the invention.

1. Liner to substantially cover at least the else ink-wetted areas of the bottom surface and possible side structures of an ink fountain (4) of radial type in a printing machine (1):
the liner being of suitable sheet material (e.g. polymer/metal/laminated cardboard etc.) of suitable thickness;
the liner at least comprising a bottom panel (for at least substantially to cover an ink fountain bottom else wetted by ink) and possible opposed suitably contoured side panels, which via bending lines/areas must be integral with the bottom panel, (for substantially to cover the else ink-wetted possible side structures of same ink fountain);
when installed in an actual ink fountain, the bottom panel's longitudinal edge nearest the nip has no positive protrusion towards the ink roller, over the fountain bottom's edge adjacent the nip;
the liner possibly comprising supplementary gripping tabs;
the liner possibly comprising added secondary adhesive fastening means in the form of spotwise applicated adhesive material; and
the liner possibly being prepared for other fastening than with adhesive means;
characterized in, when installed in the actual fountain,
the liner's (19) bottom panel (20) comprises primary adhesive means (25) extending continuously along the bottom panel's longitudinal edge (24) positioned nearest the nip (8);—the primary adhesive means (25) from the bottom panel's (20) edge (24) positioned nearest the nip (8) exhibits at least no negative protrusion (32) towards the nip/ink roller (5); and
the primary adhesive means (25) is sealingly joining the bottom panel's edge (24) nearest the nip to the ink fountain bottom (6).

2. Liner according to claim 1, characterized in, the liner (19) comprises the primary adhesive means (25) before the liner is installed in an actual ink fountain.

3. Liner according to claim 2, characterized in, the primary adhesive means (25) is applicated to the bottom panel's (20) surface to face/facing an ink fountain bottom.

4. Liner according to claim 3, characterized in, the primary adhesive means (25) in it's longitudinal direction is extended also to at least partly cover present side panels (21).

5. Liner according to claim 4, characterized in, the primary adhesive means (25) is applicated to the bottom panel in the form of a continuous tape strip (38/39).

6. Liner according to claim 5, characterized in, the primary adhesive means (25) comprising dedicated adhesives (28/29).

7. Liner according to claim 6, characterized in, the elastic bending forces at present bending lines (22)/areas are contributing to the tight placement of the end panels (21) in covering the ink fountain's end structures (11).

8. Method of manufacturing a liner according to claim 7, characterized in, the method comprising at least the following steps in any order:—application of primary adhesive means (25) continuously extending on sheet material (35) for the liner at least along predetermined length and position for liner's bottom panel's edge (24) to be positioned nearest a nip;—shaping of at least the bottom panel's edge (24) to be positioned nearest a nip by severing the liner sheet material (35), leaving possible applicated primary adhesive means (38/39) with from a minimum zero to a positive protrusion (32).

9. Method of manufacturing a liner according to claim 8, characterized in, the applicated primary adhesive means (25) is covered with protective strip material (31/39) to be peeled off during liner installation time.

10. Method of manufacturing a liner according to claim 9, characterized in, the liner sheet material (35) originates from a roll of sheet material, and the edge (24) of the liner's bottom, panel to be positioned nearest a nip, is substantially extending in the longitudinal/roll-off direction (36) of the sheet material (35).
